(19) United States
(12) Patent Application Publication
(10) Pub. No.: US 2026/0050139 A1
(43) Pub. Date: Feb. 19, 2026

(54) VISUAL OPTICAL SYSTEM AND VIRTUAL REALITY DEVICE WITH VISUAL OPTICAL SYSTEM

(71) Applicant: ZHEJIANG SUNNY OPTICS CO., LTD., Yuyao City (CN)

(72) Inventors: Ming YUAN, Yuyao City (CN); Ning LIANG, Yuyao City (CN); Xiaobin ZHANG, Yuyao City (CN); Lin HUANG, Yuyao City (CN)

(73) Assignee: ZHEJIANG SUNNY OPTICS CO., LTD., Yuyao City (CN)

(21) Appl. No.: 19/266,633

(22) Filed: Jul. 11, 2025

(30) Foreign Application Priority Data
Aug. 15, 2024 (CN) 202411129556.0

(51) Int. Cl. G02B 9/06; G02B 5/18; G02B 27/01; G02B 27/28

(52) U.S. Cl. CPC G02B 9/06; G02B 5/1876; G02B 27/0101; G02B 27/286; G02B 27/288

(57) ABSTRACT

Disclosed are a visual optical system and a virtual reality device with the visual optical system. The visual optical system includes a first lens, a composite film layer, a second lens, and a partially reflective film in sequence from a first side to a second side along an optical axis; where each of the first lens and the second lens has a positive refractive power; the composite film layer is arranged on the second side surface of the first lens, the composite film layer includes a polarizing reflective film and a quarter-wave plate, and the polarizing reflective film is located between the first lens and the quarter-wave plate; and the partially reflective film is arranged on the second side surface of the second lens, and the second side surface of the second lens is a convex surface and also a Fresnel surface.

### CROSS-REFERENCE TO RELATED APPLICATION(S)

The disclosure claims the priority to Chinese Patent Application No. 202411129556.0 filed with the Chinese Patent Office on Aug. 15, 2024, the entire contents of each of which are incorporated herein by reference for all purposes. No new matter has been introduced.

### FIELD

The disclosure relates to the field of optical devices, and in particular to a visual optical system and a virtual reality device with the visual optical system.

### BACKGROUND

The virtual reality technology is another phenomenal product after smart phones. With development of the virtual reality technology, virtual reality devices gradually transition from single magnification and projection tools to linked interactive apparatuses. A size and a weight of the virtual reality device are directly tied to a design solution of a visual optical system of the virtual reality device. However, the visual optical system is generally large in size to ensure an imaging quality. In consequence, the virtual reality device is large-sized and heavyweight, which seriously affects immersive experience of a user.

### SUMMARY

Some embodiments of the disclosure are intended to achieve a lightweight visual optical system and provide a visual optical system and a virtual reality device with the visual optical system. In an embodiment of the disclosure, a visual optical system is provided. The visual optical system includes a first lens, a composite film layer, a second lens, and a partially reflective film in sequence from a first side to a second side along an optical axis; where each of the first lens and the second lens has a positive refractive power, a first side surface located on the first side, and a second side surface located on the second side; the composite film layer is arranged on a second side surface of the first lens, the composite film layer includes a polarizing reflective film and a quarter-wave plate, and the polarizing reflective film is located between the first lens and the quarter-wave plate; and the partially reflective film is arranged on a second side surface of the second lens, and the second side surface of the second lens is a convex surface and also a Fresnel surface.

According to an exemplary embodiment of the disclosure, an effective focal length f1 of the first lens and an effective focal length f2 of the second lens satisfy: 0.75<f1/f2<3.15.

According to an exemplary embodiment of the disclosure, an effective focal length f1 of the first lens and a total effective focal length f of the visual optical system satisfy: 6≤f1/f≤17.3.

According to an exemplary embodiment of the disclosure, a center thickness CT1 of the first lens and a center thickness CT2 of the second lens satisfy: 0.3<CT1/CT2<0.8.

According to an exemplary embodiment of the disclosure, a center thickness CT1 of the first lens, a center thickness CT2 of the second lens, a refractive index N1 of the first lens, and a refractive index N2 of the second lens satisfy: 3<CT2×N2−CT1×N1<5.9.

According to an exemplary embodiment of the disclosure, a center thickness CT3 of the composite film layer and a center thickness CT1 of the first lens satisfy: 0.05≤CT3/CT1≤0.08.

According to an exemplary embodiment of the disclosure, an effective radius DT11 of a first side surface of the first lens and an effective radius DT21 of a first side surface of the second lens satisfy: 1<DT21/DT11<1.25.

According to an exemplary embodiment of the disclosure, a back focal length BFL of the visual optical system and a total track length TTL of the visual optical system satisfy: 0.1≤BFL/TTL<0.5.

According to an exemplary embodiment of the disclosure, an exit pupil distance ED of the visual optical system and a total track length TTL of the visual optical system satisfy: 0.8<ED/TTL<1.2.

According to an exemplary embodiment of the disclosure, a total effective focal length f of the visual optical system, a total track length TTL of the visual optical system, and a maximum half field of view hfov of the visual optical system satisfy: 1<f/TTL×tan(hfov)<1.8.

According to an exemplary embodiment of the disclosure, an entrance pupil diameter EPD of the visual optical system and a half image height ImgH of the visual optical system satisfy: 0.35≤EPD/ImgH≤0.36.

According to an exemplary embodiment of the disclosure, a distortion value Dist_{0.9} of the visual optical system in a field of view of 0.9 satisfies: 26%<|Dist_{0.9}|<30%.

According to an exemplary embodiment of the disclosure, one of the first side surface of the first lens and the second side surface of the first lens and the first side surface of the second lens is a planar surface.

In another embodiment of the disclosure provides a virtual reality device. The virtual reality device includes the above visual optical system.

The visual optical system provided by the disclosure includes the first lens, the composite film layer arranged on the second side surface of the first lens, the second lens, and the partially reflective film arranged on the second side surface of the second lens in sequence from the first side to the second side along the optical axis; where the composite film layer includes the quarter-wave plate and the polarizing reflective film located between the first lens and the quarter-wave plate, and the second side surface of the second lens is the convex surface and also a Fresnel surface. With the composite film layer and the partially reflective film, light rays are able to be refracted and reflected between the first lens and the second lens repeatedly. Thus, an optical path is able to be folded on the premise of ensuring an imaging quality, and a body length of the visual optical system is able to be effectively shortened. The composite film layer formed by combining the polarizing reflective film and the quarter-wave plate is able to decrease a number of attachment and improve an attachment yield. The second lens, a Fresnel lens having a positive refractive power, is able to reduce the center thickness of the second lens while fully converging and utilizing light rays from an image surface. Thus, a weight and an axial size of the visual optical system are able to be effectively reduced, and the lightweight visual optical system is able to be achieved.

### BRIEF DESCRIPTION OF DRAWINGS

Other features, objectives, and advantages of the disclosure will become apparent upon reading the detailed description of non-restrictive examples made with reference to the following accompanying drawings. In the figures:

FIG. 1 is a schematic structural diagram of a visual optical system according to Example 1 of the disclosure;

FIGS. 2A-2D show an astigmatism curve, a distortion curve, a longitudinal chromatic aberration curve, and a relative illuminance curve of the visual optical system according to Example 1 of the disclosure respectively;

FIG. 3 is a schematic structural diagram of a visual optical system according to Example 2 of the disclosure;

FIGS. 4A-4D show an astigmatism curve, a distortion curve, a longitudinal chromatic aberration curve, and a relative illuminance curve of the visual optical system according to Example 2 of the disclosure respectively;

FIG. 5 is a schematic structural diagram of a visual optical system according to Example 3 of the disclosure;

FIGS. 6A-6D show an astigmatism curve, a distortion curve, a longitudinal chromatic aberration curve, and a relative illuminance curve of the visual optical system according to Example 3 of the disclosure respectively;

FIG. 7 is a schematic structural diagram of a visual optical system according to Example 4 of the disclosure;

FIGS. 8A-8D show an astigmatism curve, a distortion curve, a longitudinal chromatic aberration curve, and a relative illuminance curve of the visual optical system according to Example 4 of the disclosure respectively; and

FIG. 9 is a sectional view of a second lens of a visual optical system according to an example of the disclosure.

### DETAILED DESCRIPTION OF EMBODIMENTS

To better understand the disclosure, various aspects of the disclosure will be described in more details with reference to accompanying drawings. It should be understood that the detailed description is merely description on exemplary embodiments of the disclosure and is not intended to limit the scope of the disclosure in any manner. In the whole description, identical reference numerals represent identical elements.

It should be noted that in the description, expressions of first, second, third, etc. are merely used for distinguishing one feature from another feature, and do not limit the feature. Thus, a first lens discussed below may be referred to as a second lens or a third lens without departing from teachings of the disclosure.

In the accompanying drawings, a thickness, a size, and a shape of a lens are slightly exaggerated for ease of illustration. Specifically, a spherical shape or an aspheric shape shown in the accompanying drawings is shown by instances. That is, the spherical shape or the aspheric shape is not limited to a spherical shape or an aspheric shape shown in the accompanying drawings. The accompanying drawings are merely instances and are not drawn to scale strictly.

Herein, a paraxial region refers to a region nearby an optical axis. If a lens surface is a convex surface and a position of the convex surface is not defined, the lens surface is a convex surface at least in the paraxial region. If the lens surface is a concave surface and a position of the concave surface is not defined, the lens surface is a concave surface at least in the paraxial region. A surface of each lens closest to a first side (such as a side configured with human eyes) is called a first side surface of the lens. A surface of each lens closest to a second side (such as a side configured with a display screen) is called a second side surface of the lens. A surface of each lens closest to an object is called an object-side surface of the lens. A surface of each lens closest to an imaging surface is called an image-side surface of the lens.

It should be further understood that terms “include” and/or “have”, used in the description, represent existence of a stated feature, element, and/or component but do not exclude existence or addition of one or more other features, elements, components, and/or their combinations. In addition, when embodiments of the disclosure are described, “may” is used to indicate “one or more embodiments of the disclosure”. Further, the term “exemplary” refers to an instance or illustration.

Unless otherwise defined, all terms (including technical terms and scientific terms) used herein have identical meanings generally understood by a person of ordinary skill in the art to which the disclosure pertains. It should be further understood that terms (for instance, terms defined in commonly used dictionaries) should be interpreted as having meanings that are consistent with their meanings in the context of the relevant art and will not be interpreted in an idealized or overly formalized sense unless expressly so defined herein.

It should be noted that examples in the disclosure and features in the examples may be combined with one another without conflicts. The disclosure will be described in detail below with reference to accompanying drawings and in combination with examples.

The features, principles, and other aspects of the disclosure are described in detail below.

In an embodiment of the disclosure, a visual optical system is provided. The visual optical system may include a first lens, a composite film layer, a second lens, and a partially reflective film in sequence from a first side to a second side along an optical axis. Each of the first lens and the second lens has a first side surface located on the first side and a second side surface located on the second side. In other words, the first side surface of the first lens is a side surface, facing away from the second lens, of the first lens, the second side surface of the first lens is a side surface, facing the second lens, of the first lens, the first side surface of the second lens is a side surface, facing the first lens, of the second lens, and the second side surface of the second lens is a side surface, facing away from the first lens, of the second lens. In a use process, the first side of the visual optical system is closest to human eyes.

In an exemplary embodiment, the composite film layer is arranged on the second side surface of the first lens, the composite film layer includes a polarizing reflective film and a quarter-wave plate, and the polarizing reflective film is located between the first lens and the quarter-wave plate; and the partially reflective film is arranged on the second side surface of the second lens. The visual optical system is provided with an image surface located on the second side. After light rays from the image surface are irradiated onto the partially reflective film, part of the light rays transmit through the partially reflective film and sequentially passes through the second lens and the quarter-wave plate. The light rays have a polarized state changed after passing through the quarter-wave plate, and initial circularly polarized light from the image surface is changed into initial linearly polarized light. Then, the light rays are reflected for the first time at the polarizing reflective film, resulting primarily-reflected light rays sequentially pass through the quarter-wave plate and the second lens, and the linearly polarized light is changed back to the circularly polarized light when passing through the quarter-wave plate. Next, the primarily-reflected light rays are reflected for the second time at the partially reflective film, and resulting secondarily-reflected light rays have a rotation direction opposite to that of the original circularly polarized light. Next, the secondarily-reflected light rays sequentially pass through the second lens and the quarter-wave plate and become linearly polarized light perpendicular to a direction of the initial linearly polarized light at the quarter-wave plate, so as to pass through the polarizing reflective film. Finally, the secondarily-reflected light rays sequentially pass through the polarizing reflective film and the second lens to enter eyes of a user. In view of the above, with the composite film layer and the partially reflective film, the light rays are able to be refracted and reflected between the first lens and the second lens repeatedly. Thus, an optical path is able to be folded on the premise of ensuring an imaging quality, and a body length of the visual optical system is able to be effectively shortened. The composite film layer formed by combining the polarizing reflective film and the quarter-wave plate is able to decrease a number of attachment and improve an attachment yield.

In an embodiment, the image surface may be provided with a display screen, and light rays from the display screen are refracted and reflected between the first lens and the second lens repeatedly and then projected to the eyes of the user.

In an exemplary embodiment, the partially reflective film may be a semi-transparent and semi-reflective film, with a transmittance and a reflectance both close to 50%. In other embodiments, a reflectance and a transmittance of the partially reflective film may be adjusted according to specific design demand, and the reflectance may also be 40%, 45%, 55%, 60%, 65%, etc.

In an exemplary embodiment, the first lens and the second lens have each a positive refractive power, and the second side surface of the second lens is a convex surface and also a Fresnel surface. The second lens, a Fresnel lens having a positive refractive power, is able to reduce a center thickness of the second lens while fully converging and utilizing the light rays from the image surface. Thus, a weight and an axial size of the visual optical system are able to be effectively reduced, and a lightweight visual optical system is able to be achieved.

In an exemplary embodiment, the composite film layer is attached to the second side surface of the first lens, and the partially reflective film is attached to the second side surface of the second lens.

In an exemplary embodiment, one of the first side surface of the first lens, the second side surface of the first lens and the first side surface of the second lens is a planar surface. The second side surface of the first lens is configured as the planar surface, so that the composite film layer is attached to the second side surface of the first lens conveniently. Thus, an attachment effect of the composite film layer is improved, and reduction in polarization efficiency caused by an obvious angle effect of the light rays at the composite film layer is avoided.

In an exemplary embodiment, the visual optical system further includes a diaphragm. The diaphragm may be arranged on a side, facing away from the second lens, of the first lens. The light rays from the display screen are refracted and reflected between the first lens and the second lens repeatedly and then projected to the eyes of the user through the diaphragm.

In an exemplary embodiment, an effective focal length f1 of the first lens and an effective focal length f2 of the second lens satisfy: 0.75<f1/f2<3.15. The control over a range of a ratio of the effective focal length of the first lens to the effective focal length of the second lens is able to be fed back to a radius of curvature design process and a material refractive index selection process of the first lens and the second lens. Thus, outward protruding of the lens caused by an excessively-large radius of curvature of the lens is avoided, the comfort of the human eyes in the use process is ensured, and the risk of interference between the second lens and the display screen is reduced.

In an exemplary embodiment, the effective focal length f1 of the first lens and a total effective focal length f of the visual optical system satisfy: 6≤f1/f≤17.3. By defining a ratio of the effective focal length of the first lens to the total effective focal length of the visual optical system, material selection and radius of curvature design of the first lens are facilitated, and the influence on an appearance of the visual optical system due to the outward protruding of the lens caused by the excessively-large radius of curvature of the lens is avoided.

In an exemplary embodiment, a center thickness CT1 of the first lens and a center thickness CT2 of the second lens satisfy: 0.3<CT1/CT2<0.8. By defining a ratio of the center thickness of the first lens to the center thickness of the second lens, the optical path of the light rays are assigned between the first lens and the second lens, so that the axial size of the visual optical system is compressed by folding back the optical path to the greatest extent. Moreover, the design of the visual optical system is able to be restricted, and the increase in forming difficulty and the decrease in system reliability caused by a big difference between the center thicknesses of the first lens and the second lens are able to be avoided.

In an exemplary embodiment, the center thickness CT1 of the first lens, the center thickness CT2 of the second lens, a refractive index N1 of the first lens, and a refractive index N2 of the second lens satisfy: 3<CT2×N2−CT1×N1<5.9. By enabling the center thicknesses and refractive indexes of the first lens and the second lens to satisfy the above numerical relation, material selection of the lenses is able to be restricted to achieve desirable refractive power conversion. Moreover, the center thicknesses of the lenses are able to be controlled, so that the reduction in lens strength caused by a too lightweight lens is able to be avoided, and the lens forming difficulty is able to be controlled.

In an exemplary embodiment, a center thickness CT3 of the composite film layer and the center thickness CT1 of the first lens satisfy: 0.05≤CT3/CT1≤0.08. The center thickness of the composite film layer indicates a thickness value of the composite film layer along the optical axis. The thickness of the composite film layer is controlled by defining a ratio of the center thickness of the composite film layer to the center thickness of the first lens. Thus, the optical path is utilized to the greatest extent while an imaging capability of the visual optical system is ensured, and the axial size of the visual optical system is further compressed.

In an exemplary embodiment, an effective radius DT11 of the first side surface of the first lens and an effective radius DT21 of the first side surface of the second lens satisfy: 1<DT21/DT11<1.25. By defining a ratio of effective radius sizes of the first side surfaces of the first lens and the second lens, smooth transition of light rays is facilitated, and an angle effect and a dispersion effect generated at a film due to an excessively-large incident angle are avoided. Moreover, the visual optical system further includes a lens barrel, where the first lens and the second lens are located in the lens barrel. Through the above defining, a lens size is restricted, so that the design of the lens barrel is facilitated, and abnormal demolding of the lens barrel caused by an excessively-large aperture ratio of the first lens to the second lens is avoided.

In an exemplary embodiment, a back focal length BFL of the visual optical system and a total track length TTL of the visual optical system satisfy: 0.1≤BFL/TTL<0.5. The back focal length BFL indicates an on-axis distance from the second side surface of the second lens to the image surface, and the total track length TTL indicates an on-axis distance from the first side surface of the first lens to the image surface. By defining a ratio of the back focal length to the total track length of the visual optical system, the radius of curvature of the second lens is able to be controlled while a relation between the back focal length and the total track length is able to be restricted. Thus, the interference with the screen caused by the excessively-protruding second lens is avoided, the process difficulty is reduced, and the reliability of the optical system is improved.

In an exemplary embodiment, an exit pupil distance ED of the visual optical system and an total track length TTL of the visual optical system satisfy: 0.8<ED/TTL<1.2. The exit pupil distance ED indicates an on-axis distance from the human eyes to the first side of the first lens in the use process of the visual optical system, and the total track length TTL indicates an on-axis distance from the first side surface of the first lens to the image surface. By defining a ratio of the exit pupil distance to the total track length of the visual optical system, the exit pupil distance is ensured to satisfy near-eye display demand in a case of controlling the total track length. Thus, vision blur and eye fatigue caused by imaging of the visual optical system in front of or behind the retina are avoided.

In an exemplary embodiment, a total effective focal length f of the visual optical system, a total track length TTL of the visual optical system, and a maximum half field of view hfov of the visual optical system satisfy: 1<f/TTL×tan(hfov)<1.8. By enabling the total effective focal length, the total track length, and the maximum half field of view of the visual optical system satisfy the above numerical relation, a magnitude relation between the total track length and the field of view is controlled, so as to obtain a small optical total track length and a large field of view simultaneously and add the immersive feeling in the use process.

In an exemplary embodiment, an entrance pupil diameter EPD of the visual optical system and a half image height ImgH of the visual optical system satisfy: 0.35≤EPD/ImgH≤0.36. The half image height ImgH indicates a half of a diagonal length of an effective pixel region on the image surface. By defining a ratio of the entrance pupil diameter to the half image height of the visual optical system, the field of view is able to be preliminarily restricted, so that the design of a large field of view is able to be achieved, and the immersive feeling in the use process is able to be added. Moreover, a pupil deviation space is able to be taken into consideration, and an eye movement range is able to be expanded. Further, a size of the display screen is able to be indirectly restricted, so that model selection is able to be facilitated.

In an exemplary embodiment, the total track length TTL, the half image height ImgH, an f-number (FNO), the back focal length BFL, the entrance pupil diameter EPD, the total effective focal length f, the effective focal length f1 of the first lens, and the effective focal length f2 of the second lens of the visual optical system satisfy: 14 mm≤TTL≤19 mm, 14 mm≤ImgH≤14.1 mm, 3.4≤FNO≤3.7, 1.3 mm≤BFL≤9 mm, 17 mm≤f≤18.5 mm, 110 mm≤f1≤300 mm, and 95 mm≤f2≤150 mm.

In an exemplary embodiment, a distortion value Dist_{0.9} of the visual optical system in a field of view of 0.9 satisfies: 26%<|Dist_{0.9}|<30%. By defining the distortion value of the visual optical system in the field of view of 0.9, a distortion pre-compensation algorithm is set, an excessive of edge frame loss caused by excessive distortion compensation clipping is avoided, and an imaging quality is improved.

However, those skilled in the art should understand that a number of constituent lenses may be changed to achieve various results and advantages described in the description without departing from the claimed technical solution of the disclosure.

In another embodiment of the disclosure, a visual optical system is provided. The visual optical system includes a first lens, a composite film layer, a second lens, and a partially reflective film in sequence from a first side to a second side along an optical axis; where each of the first lens and the second lens has a positive refractive power, a first side surface located on the first side, and a second side surface located on the second side; the composite film layer is arranged on the second side surface of the first lens, the composite film layer includes a polarizing reflective film and a quarter-wave plate, and the polarizing reflective film is located between the first lens and the quarter-wave plate; the partially reflective film is arranged on the second side surface of the second lens, and the second side surface of the second lens is a convex surface and also a Fresnel surface; and a back focal length BFL of the visual optical system and a total track length TTL of the visual optical system satisfy: 0.1≤BFL/TTL<0.5. The back focal length BFL indicates an on-axis distance from the second side surface of the second lens to the image surface, and the total track length TTL indicates an on-axis distance from the first side surface of the first lens to the image surface. By defining a ratio of the back focal length to the total track length of the visual optical system, a radius of curvature of the second lens is able to be controlled while a relation between the back focal length and the total track length are able to be restricted. Thus, the interference with the display screen caused by the excessively-protruding second lens is avoided, the process difficulty is reduced, and the reliability of the optical system is improved.

In yet another embodiment of the disclosure, a visual optical system is provided. The visual optical system includes a first lens, a composite film layer, a second lens, and a partially reflective film in sequence from a first side to a second side along an optical axis; where each of the first lens and the second lens has a positive refractive power, a first side surface located on the first side, and a second side surface located on the second side; the composite film layer is arranged on the second side surface of the first lens, the composite film layer includes a polarizing reflective film and a quarter-wave plate, and the polarizing reflective film is located between the first lens and the quarter-wave plate; the partially reflective film is arranged on the second side surface of the second lens, and the second side surface of the second lens is a convex surface and also a Fresnel surface; and a total effective focal length f of the visual optical system, a total track length TTL of the visual optical system, and a maximum half field of view hfov of the visual optical system satisfy: 1<f/TTL×tan(hfov)<1.8. By enabling the total effective focal length, the total track length, and the maximum half field of view of the visual optical system satisfy the above numerical relation, a magnitude relation between the total track length and the field of view is controlled, so as to obtain a small optical total track length and a large field of view simultaneously and add the immersive feeling in a use process.

In still another embodiment of the disclosure, a visual optical system is provided. The visual optical system includes a first lens, a composite film layer, a second lens, and a partially reflective film in sequence from a first side to a second side along an optical axis; where each of the first lens and the second lens has a positive refractive power, a first side surface located on the first side, and a second side surface located on the second side; the composite film layer is arranged on the second side surface of the first lens, the composite film layer includes a polarizing reflective film and a quarter-wave plate, and the polarizing reflective film is located between the first lens and the quarter-wave plate; the partially reflective film is arranged on the second side surface of the second lens, and the second side surface of the second lens is a convex surface and also a Fresnel surface; and an exit pupil distance ED of the visual optical system and a total track length TTL of the visual optical system satisfy: 0.8<ED/TTL<1.2. The exit pupil distance ED indicates an on-axis distance from human eyes to the first side of the first lens in the use process of the visual optical system, and the total track length TTL indicates an on-axis distance from the first side surface of the first lens to the image surface. By defining a ratio of the exit pupil distance to the total track length of the visual optical system, the exit pupil distance is ensured to satisfy near-eye display demand in a case of controlling the total track length. Thus, vision blur and eye fatigue caused by imaging of the visual optical system in front of or behind the retina are avoided.

In still another embodiment of the disclosure, a visual optical system is provided disclosure. The visual optical system includes a first lens, a composite film layer, a second lens, and a partially reflective film in sequence from a first side to a second side along an optical axis; where each of the first lens and the second lens has a positive refractive power, a first side surface located on the first side, and a second side surface located on the second side; the composite film layer is arranged on the second side surface of the first lens, the composite film layer includes a polarizing reflective film and a quarter-wave plate, and the polarizing reflective film is located between the first lens and the quarter-wave plate; the partially reflective film is arranged on the second side surface of the second lens, and the second side surface of the second lens is a convex surface and also a Fresnel surface; and an entrance pupil diameter EPD of the visual optical system and a half image height ImgH of the visual optical system satisfy: 0.35≤EPD/ImgH≤0.36. The half image height ImgH indicates a half of a diagonal length of an effective pixel region on the image surface. By defining a ratio of the entrance pupil diameter to the half image height of the visual optical system, the field of view is able to be preliminarily restricted, so that the design of a large field of view is able to be achieved, and the immersive feeling in the use process is able to be added. Moreover, a pupil deviation space is able to be taken into consideration, and an eye movement range is able to be expanded. Further, a size of the display screen is able to be indirectly restricted, so that model selection is able to be facilitated.

In an embodiment of the disclosure, a virtual reality device is provided. The virtual reality device includes any one of the visual optical systems provided above. One or more visual optical systems may be provided.

Specific examples of the visual optical system applicable to the above embodiments are further described below with reference to the accompanying drawings.

### Example 1

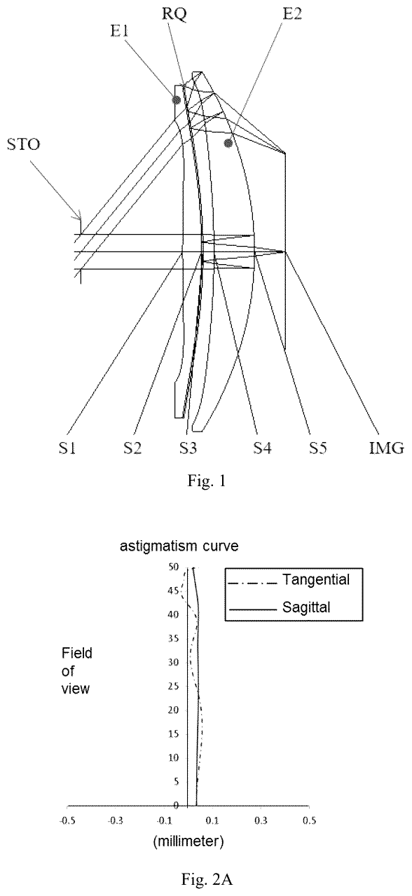

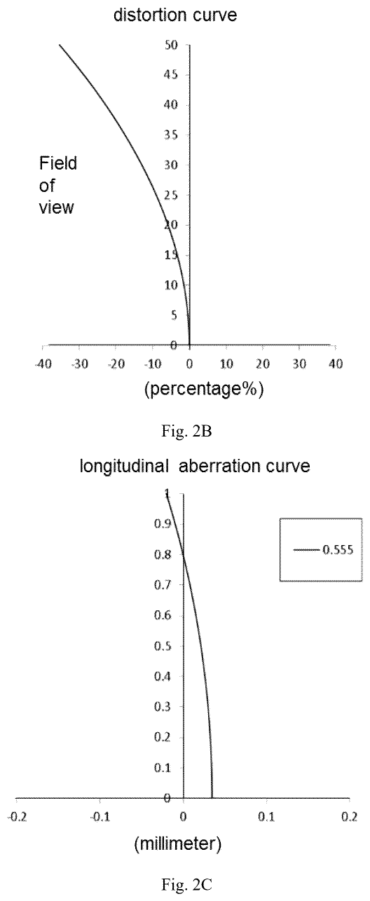

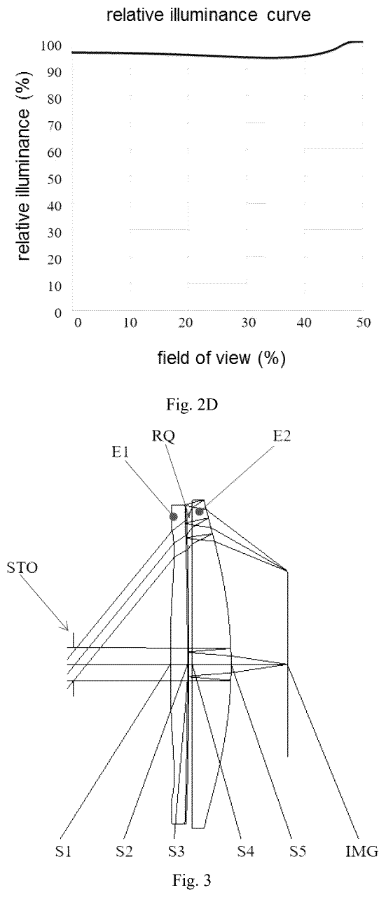

The visual optical system according to the example is described below with reference to FIGS. 1-2D.

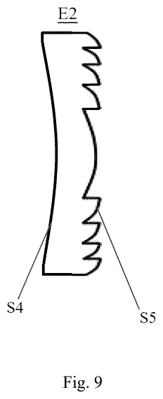

As shown in FIG. 1, the visual optical system includes a diaphragm STO, a first lens E1, a composite film layer RQ, a second lens E2, and a partially reflective film BS in sequence from a first side to a second side along an optical axis. The first lens E1 has a positive refractive power, and a first side surface of the first lens S1 and a second side surface S2 of the first lens are convex surfaces. The composite film layer RQ is arranged on the second side surface S2 of the first lens, a second side surface S3 of the composite film layer RQ faces away from the first lens E1, the composite film layer RQ includes a polarizing reflective film RP and a quarter-wave plate QWP that are arranged in a stacked manner, and the quarter-wave plate QWP is arranged on a side surface S25, facing away from the first lens, of the polarizing reflective film RP. The second lens E2 has a positive refractive power, as shown in FIG. 9, a first side surface S4 of the second lend is a concave surface, a second side surface S5 of the second lens is a convex surface and also a Fresnel surface, and the Fresnel surface consists of a base surface S52 and a Fresnel facet S51. The partially reflective film BS is arranged on the second side surface S5 of the second lens. The visual optical system is provided with an image surface (IMG) located on the second side, the image surface is provided with a display screen, and in a use process, the first side of the visual optical system is closest to human eyes.

After light rays from the image surface IMG is irradiated onto the partially reflective film BS, part of the light rays transmit through the partially reflective film BS and sequentially pass through the second lens E2 and the quarter-wave plate QWP, and then are reflected for the first time at the polarizing reflective film RP. Resulting primarily-reflected light rays sequentially pass through the quarter-wave plate QWP and the second lens E2 and then are reflected for the second time at the partially reflective film BS. Finally, resulting secondarily-reflected light rays sequentially pass through the second lens E2, the quarter-wave plate QWP, the polarizing reflective film RP, the second lens E2, and the diaphragm STO and then enters eyes of a user. Table 1 shows basic parameters of the visual optical system in the example. Units of a radius of curvature and a thickness/distance are millimeter (mm). The light rays from the image surface IMG pass through each element in an order from number 13 to number 1 in Table 1, and is finally projected into the human eyes. “Surface numbers” in rows of number 12 to number 2 correspond to surfaces where refraction or reflection is generated of the “elements” in the corresponding rows. “Thickness/distance” data in the row of number 12 indicate a back focal length of the visual optical system and is equal to the sum of a distance from the partially reflective film BS to the image surface and a center thickness of the partially reflective film BS.

TABLE 1

| | | Surface | Surface | Radius of | Thickness/ | Refractive | Abbe | Refraction/ | Effective |
|---|---|---|---|---|---|---|---|---|---|
| Number | Element | number | type | curvature | distance | index | number | reflection | radius |
| 1 | Diaphragm (STO) | STO | Spherical | Infinite | 15 | | | | 2.5 |
| | | | surface | | | | | | |
| 2 | First lens (E1) | S1 | Aspheric | 269.676 | 2.8009 | 1.54 | 55.9 | Refraction | 18.9147 |
| | | | surface | | | | | | |
| 3 | Composite film | S2 | Aspheric | −77.8122 | 0.209 | 1.5 | 57 | Refraction | 23.8964 |
| | layer (RQ) | | surface | | | | | | |
| 4 | | S3 | Aspheric | −77.8122 | 1.6211 | | | Refraction | 23.8964 |
| | | | surface | | | | | | |
| 5 | Second lens (E2) | S4 | Aspheric | −117.6201 | 6.0002 | 1.54 | 56 | Refraction | 24.8432 |
| | | | surface | | | | | | |
| 6 | Second lens (E2) | S5 | Fresnel | −44.2877 | −6.0002 | | | Reflection | 25.809 |
| | | | surface | | | | | | |
| 7 | | S4 | Aspheric | −117.6201 | −1.6211 | | | Refraction | 24.8432 |
| | | | surface | | | | | | |
| 8 | Quarter-wave plate | S3 | Aspheric | −77.8122 | −0.209 | 1.5 | 57 | Refraction | 23.8964 |
| | (QWP) | | surface | | | | | | |
| 9 | Quarter-wave plate | S25 | Aspheric | −77.8122 | 0.209 | | | Reflection | 23.8964 |
| | (QWP) | | surface | | | | | | |
| 10 | | S3 | Aspheric | −77.8122 | 1.6211 | | | Refraction | 23.8964 |
| | | | surface | | | | | | |
| 11 | Second lens (E2) | S4 | Aspheric | −117.6201 | 6.0002 | 1.54 | 56 | Refraction | 24.8432 |
| | | | surface | | | | | | |
| 12 | Partially reflective | S5 | Fresnel | −44.2877 | 4.6143 | | | Refraction | 25.809 |
| | film (BS) | | surface | | | | | | |
| 13 | Image surface | IMG | Spherical | Infinite | 0 | | | Refraction | 14.0938 |
| | | | surface | | | | | | |

In the example, the first side surface S1 of the first lens and the second side surface S2 of the first lens and the first side surface S4 of the second lens are aspheric surfaces, and a surface type x of each aspheric lens may be defined by, but not limited to, an aspheric surface formula as follows:

$$x = \frac{{ch}^{2}}{1 + \sqrt{1 - ( k + 1 ) {c}^{2} {h}^{2}}} + \sum {Ath}^{i} \qquad ( 1 )$$

In the above formula, x denotes a distance vector height to a vertex of the aspheric surface at a height h in a direction of the optical axis; c denotes a paraxial curvature of the aspheric surface, where c=1/R (in other words, the paraxial curvature c is a reciprocal of the radius R of curvature in Table 1); k denotes a conic coefficient; and Ai denotes a correction coefficient of an i-th order of the aspheric surface. The base surface S52 and the Fresnel facet S51 of the second side surface S5 of the second lens are also applicable to the formula (1). Table 2 shows a conic coefficient k and higher-order coefficients A₂, A₄, A₆, A₈, A₁₀, A₁₂, A₁₄, A₁₆, and A₁₈ that are applicable to the surfaces S1-S5 in the example.

TABLE 2

| Surface | | | | | |
|---|---|---|---|---|---|
| number | k | A₂ | A₄ | A₆ | A₈ |
| S1 | 72.91068 | 0 | −5.56E−06 | 3.57E−08 | −3.72E−10 |
| S2 | 0.950987 | 0 | 4.25E−06 | −4.54E−09 | −3.47E−12 |
| S3 | 0.950987 | 0 | 4.25E−06 | −4.54E−09 | −3.47E−12 |
| S4 | −9.18853 | 0 | 9.78E−08 | 2.63E−09 | 7.81E−13 |
| S51 | −0.89398 | 6.00E+00 | −3.96E+132 | −5.75E+33 | 0.00E+00 |
| S52 | −0.89398 | 0 | −2.05579E−07 | 8.11281E−10 | −9.84813E−13 |

| Surface | | | | | |
|---|---|---|---|---|---|
| number | A₁₀ | A₁₂ | A₁₄ | A₁₆ | A₁₈ |
| S1 | 1.09E−12 | −1.51E−15 | 0.00E+00 | 0.00E+00 | 0.00E+00 |
| S2 | 2.65E−14 | −2.21E−17 | 0.00E+00 | 0.00E+00 | 0.00E+00 |
| S3 | 2.65E−14 | −2.21E−17 | 0.00E+00 | 0.00E+00 | 0.00E+00 |
| S4 | −1.75E−14 | 7.71E−19 | 0.00E+00 | 0.00E+00 | 0.00E+00 |
| S51 | −4.57E−07 | 1.75E−10 | −1.95E−12 | −4.13E−15 | 4.00E−19 |
| S52 | −2.48095E−15 | 2.24229E−18 | 0.00E+00 | 0.00E+00 | 0.00E+00 |

In the visual optical system according to the example, the total track length TTL is 15.25 mm, the exit pupil distance ED is 15 mm, the half image height ImgH is 14.09 mm, the maximum half field of view hfov is 50°, the f-number FNO is 3.63, the distance TD from the first side surface of the first lens to the second side surface of the second lens along the optical axis is 10.63 mm, the back focal length BFL is 4.61 mm, the total effective focal length f is 18.15 mm, the effective focal length f1 of the first lens is 112.84 mm, and the effective focal length f2 of the second lens is 126.52 mm.

FIG. 2A shows an astigmatism curve of the visual optical system according to the example and indicates degrees of curvature of tangential image surfaces and degrees of curvature of sagittal image surfaces corresponding to different fields of view. FIG. 2B shows a distortion curve of the visual optical system according to the example and indicates distortion values corresponding to different fields of view. A distortion value Dist_{0.9} in a field of view of 0.9 is able to be derived from FIG. 2B, where the distortion value Dist_{0.9} is a distortion value in a field of view of 45°. FIG. 2C shows a longitudinal chromatic aberration curve of the visual optical system according to the example and indicates a degree of deviation of a converged focusing point generated after light having different wavelengths passes through the visual optical system. FIG. 2D shows a relative illuminance curve of the visual optical system according to the example and indicates relative illuminance values corresponding to different fields of view of the visual optical system. As can be seen from FIGS. 2A to 2D, the visual optical system according to the example is able to achieve a desirable imaging quality.

### Example 2

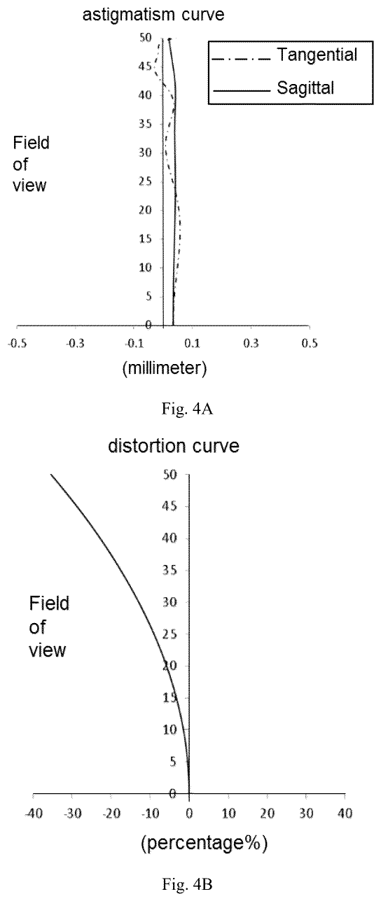

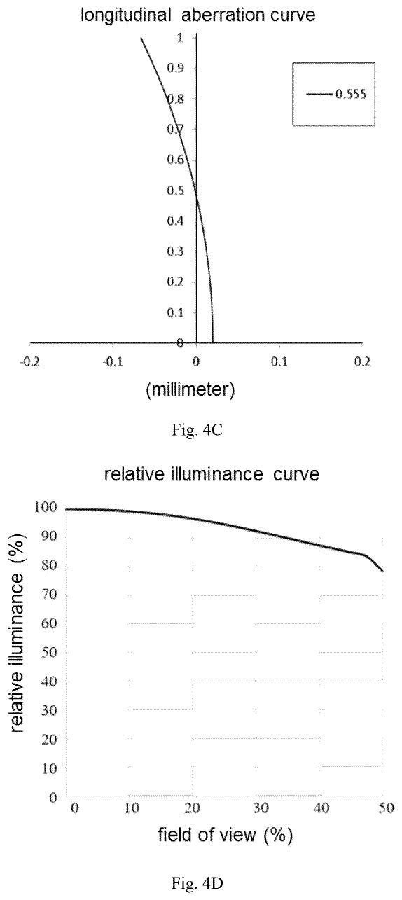

The visual optical system according to the example is described below with reference to FIGS. 3-4D.

As shown in FIG. 3, the visual optical system includes a diaphragm STO, a first lens E1, a composite film layer RQ, a second lens E2, and a partially reflective film BS in sequence from a first side to a second side along an optical axis. The first lens E1 has a positive refractive power, and a first side surface S1 and a second side surface S2 of the first lens are convex surfaces. The composite film layer RQ is arranged on the second side surface S2 of the first lens, a second side surface S3 of the composite film layer RQ faces away from the first lens E1, the composite film layer RQ includes a polarizing reflective film RP and a quarter-wave plate QWP that are arranged in a stacked manner, and the quarter-wave plate QWP is arranged on a side surface S25, facing away from the first lens, of the polarizing reflective film RP. The second lens E2 has a positive refractive power, a first side surface S4 of the second lens is a planar surface, and a second side surface S5 of the second lens is a convex surface and also a Fresnel surface. The partially reflective film BS is arranged on the second side surface S5 of the second lens. The Fresnel surface consists of a base surface S52 and a Fresnel facet S51. The visual optical system is provided with an image surface IMG located on the second side, the image surface is provided with a display screen, and in a use process, the first side of the visual optical system is closest to human eyes.

After light rays from the image surface IMG is irradiated onto the partially reflective film BS, part of the light rays transmit through the partially reflective film BS and sequentially pass through the second lens E2 and the quarter-wave plate QWP, and then are reflected for the first time at the polarizing reflective film RP. Resulting primarily-reflected light rays sequentially pass through the quarter-wave plate QWP and the second lens E2 and then are reflected for the second time at the partially reflective film BS. Finally, resulting secondarily-reflected light rays sequentially pass through the second lens E2, the quarter-wave plate QWP, the polarizing reflective film RP, the second lens E2, and the diaphragm STO and then enters eyes of a user. Table 3 shows basic parameters of the visual optical system in the example. Units of a radius of curvature and a thickness/distance are millimeter (mm). The light from the image surface IMG passes through each element in an order from number 13 to number 1 in Table 3 and is finally projected into the human eyes. “Surface numbers” in rows of number 12 to number 2 correspond to surfaces where refraction or reflection is generated of the “elements” in the corresponding rows. “Thickness/distance” data in the row of number 12 indicate a back focal length of the visual optical system and is equal to the sum of a distance from the partially reflective film BS to the image surface and a center thickness of the partially reflective film BS.

TABLE 3

| | | Surface | Surface | Radius of | Thickness/ | Refractive | Abbe | Refraction/ | Effective |
|---|---|---|---|---|---|---|---|---|---|
| Number | Element | number | type | curvature | distance | index | number | reflection | radius |
| 1 | Diaphragm (STO) | STO | Spherical | Infinite | 15 | | | | 2.5 |
| | | | surface | | | | | | |
| 2 | First lens (E1) | S1 | Aspheric | 210.5336 | 2.6715 | 1.54 | 55.9 | Refraction | 20.0688 |
| | | | surface | | | | | | |
| 3 | Composite film | S2 | Aspheric | −667.2257 | 0.209 | 1.5 | 57 | Refraction | 23.9998 |
| | layer (RQ) | | surface | | | | | | |
| 4 | | S3 | Aspheric | −667.2257 | 0.5364 | | | Refraction | 23.9998 |
| | | | surface | | | | | | |
| 5 | Second lens (E2) | S4 | Spherical | Infinite | 6.0018 | 1.66 | 20.4 | Refraction | 24.3515 |
| | | | surface | | | | | | |
| 6 | Second lens (E2) | S5 | Fresnel | −63.676 | −6.0018 | | | Reflection | 24.7316 |
| | | | surface | | | | | | |
| 7 | | S4 | Spherical | Infinite | −0.5364 | | | Refraction | 24.3515 |
| | | | surface | | | | | | |
| 8 | Quarter-wave plate | S3 | Aspheric | −667.2257 | −0.209 | 1.5 | 57 | Refraction | 23.9998 |
| | (QWP) | | surface | | | | | | |
| 9 | Quarter-wave plate | S25 | Aspheric | −667.2257 | 0.209 | | | Reflection | 23.9998 |
| | (QWP) | | surface | | | | | | |
| 10 | | S3 | Aspheric | −667.2257 | 0.5364 | | | Refraction | 23.9998 |
| | | | surface | | | | | | |
| 11 | Second lens (E2) | S4 | Spherical | Infinite | 6.0018 | 1.66 | 20.4 | Refraction | 24.3515 |
| | | | surface | | | | | | |
| 12 | Partially reflective | S5 | Fresnel | −63.676 | 8.7712 | | | Refraction | 24.7316 |
| | film (BS) | | surface | | | | | | |
| 13 | Image surface | IMG | Spherical | Infinite | 0 | | | Refraction | 13.9996 |
| | | | surface | | | | | | |

In the example, the first side surface S1 and the second side surface S2 of the first lens are aspheric surfaces. Table 4 shows a conic coefficient k and higher-order coefficients A₂, A₄, A₆, A₈, A₁₀, A₁₂, A₁₄, A₁₆, and A₁₈ that are applicable to the surfaces S1-S3 and S5 in the example.

TABLE 4

| Surface | | | | | | | | | | |
|---|---|---|---|---|---|---|---|---|---|---|
| number | k | A₂ | A₄ | A₆ | A₈ | A₁₀ | A₁₂ | A₁₄ | A₁₆ | A₁₈ |
| S1 | 99.50569 | 0 | −1.64E−06 | 5.47E−08 | −4.03E−10 | 9.56E−13 | −9.53E−16 | 0.00E+00 | 0.00E+00 | 0.00E+00 |
| S2 | 0 | 0.00E+00 | 0.00E+00 | 0.00E+00 | 0.00E+00 | 0.00E+00 | 0.00E+00 | 0.00E+00 | 0.00E+00 | 0.00E+00 |
| S3 | 0 | 0.00E+00 | 0.00E+00 | 0.00E+00 | 0.00E+00 | 0.00E+00 | 0.00E+00 | 0.00E+00 | 0.00E+00 | 0.00E+00 |
| S51 | −1.68824 | 6.00E+00 | 2.77E+131 | −2.30E+37 | 0.00E+00 | −6.06E−08 | 5.62E−10 | −4.00E−12 | −3.04E−15 | 2.43E−18 |
| S52 | −1.68824 | 0 | 5.00E−08 | 2.40E−09 | −2.45E−12 | −1.53E−16 | 5.47E−18 | 0.00E+00 | 0.00E+00 | 0.00E+00 |

In the visual optical system according to the example, the total track length TTL is 18.19 mm, the exit pupil distance ED is 15 mm, the half image height ImgH is 14 mm, the maximum half field of view hfov is 50°, the f-number FNO is 3.45, the distance TD from the first side surface of the first lens to the second side surface of the second lens along the optical axis is 9.42 mm, the back focal length BFL is 8.77 mm, the total effective focal length f is 17.26 mm, the effective focal length f1 of the first lens is 298.47 mm, and the effective focal length f2 of the second lens is 95.54 mm.

FIG. 4A shows an astigmatism curve of the visual optical system according to the example and indicates degrees of curvature of tangential image surfaces and degrees of curvature of sagittal image surfaces corresponding to different fields of view. FIG. 4B shows a distortion curve of the visual optical system according to the example and indicates distortion values corresponding to different fields of view. It can be seen from FIG. 4B that a distortion value Dist_{0.9} in a field of view of 0.9 is obtained, where the distortion value Dist_{0.9} is a distortion value in a field of view of 45°. FIG. 4C shows a longitudinal chromatic aberration curve of the visual optical system according to the example and indicates a degree of deviation of a converged focusing point generated after light having different wavelengths passes through the visual optical system. FIG. 4D shows a relative illuminance curve of the visual optical system according to the example and indicates relative illuminance values corresponding to different fields of view of the visual optical system. As can be seen from FIGS. 4A to 4D, the visual optical system according to the example is able to achieve a desirable imaging quality.

### Example 3

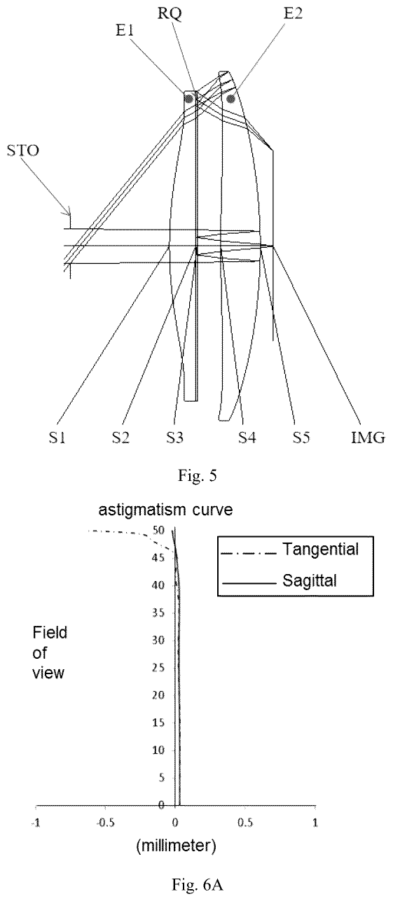

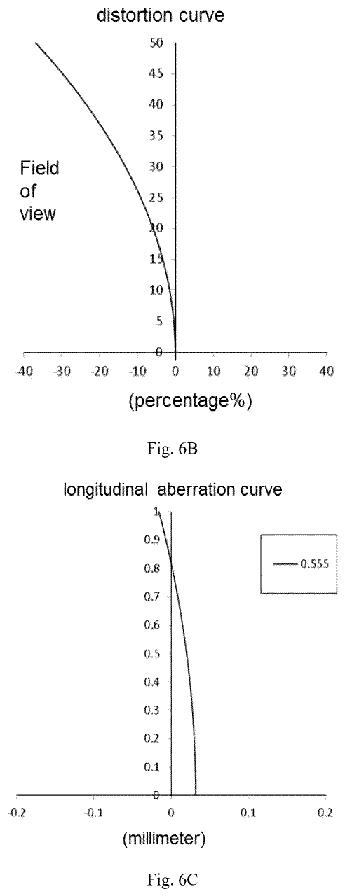

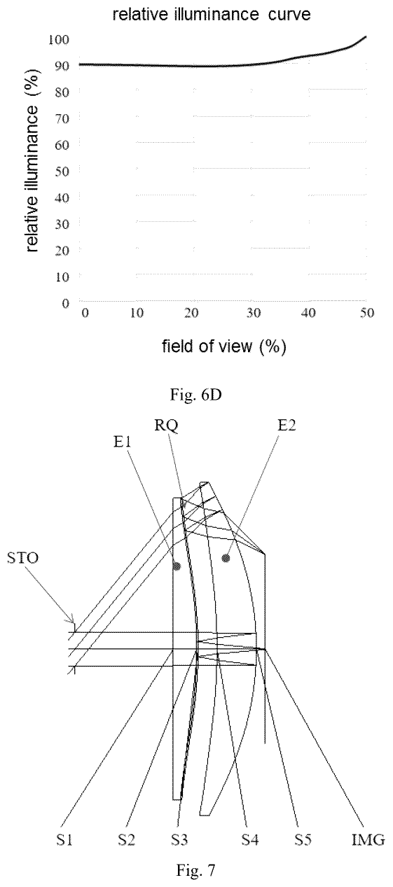

The visual optical system according to the example is described below with reference to FIGS. 5-6D.

As shown in FIG. 5, the visual optical system includes a diaphragm STO, a first lens E1, a composite film layer RQ, a second lens E2, and a partially reflective film BS in sequence from a first side to a second side along an optical axis. The first lens E1 has a positive refractive power, a first side surface S1 of the first lens is a convex surface, and a second side surface S2 of the first lens is a planar surface. The composite film layer RQ is arranged on the second side surface S2 of the first lens, a second side surface S3 of the composite film layer RQ faces away from the first lens E1, the composite film layer RQ includes a polarizing reflective film RP and a quarter-wave plate QWP that are arranged in a stacked manner, and the quarter-wave plate QWP is arranged on a side surface S25, facing away from the first lens, of the polarizing reflective film RP. The second lens E2 has a positive refractive power, a first side surface S4 of the second lens is a convex surface, and a second side surface S5 of the second lens is a convex surface and also a Fresnel surface. The partially reflective film BS is arranged on the second side surface S5 of the second lens. The Fresnel surface consists of a base surface S52 and a Fresnel facet S51. The visual optical system is provided with an image surface IMG located on the second side, the image surface is provided with a display screen, and in a use process, the first side of the visual optical system is closest to human eyes.

After light rays from the image surface IMG is irradiated onto the partially reflective film BS, part of the light rays transmit through the partially reflective film BS and sequentially pass through the second lens E2 and the quarter-wave plate QWP, and then are reflected for the first time at the polarizing reflective film RP. Resulting primarily-reflected light rays sequentially pass through the quarter-wave plate QWP and the second lens E2 and then are reflected for the second time at the partially reflective film BS. Finally, resulting secondarily-reflected light rays sequentially pass through the second lens E2, the quarter-wave plate QWP, the polarizing reflective film RP, the second lens E2, and the diaphragm STO and then enters eyes of a user. Table 5 shows basic parameters of the visual optical system in the example. Units of a radius of curvature and a thickness/distance are millimeter (mm). The light from the image surface IMG passes through each element in an order from number 13 to number 1 in Table 5 and is finally projected into the human eyes. “Thickness/distance” data in a row of number 12 indicate a back focal length of the visual optical system and is equal to the sum of a distance from the partially reflective film BS to the image surface and a center thickness of the partially reflective film BS.

TABLE 5

| | | Surface | Surface | Radius of | Thickness/ | Refractive | Abbe | Refraction/ | Effective |
|---|---|---|---|---|---|---|---|---|---|
| Number | Element | number | type | curvature | distance | index | number | reflection | radius |
| 1 | Diaphragm (STO) | STO | Spherical | Infinite | 15 | | | | 2.5 |
| | | | surface | | | | | | |
| 2 | First lens (E1) | S1 | Aspheric | 59.3217 | 4 | 1.54 | 55.9 | Refraction | 19.8308 |
| | | | surface | | | | | | |
| 3 | Composite film | S2 | Spherical | Infinite | 0.209 | 1.5 | 57 | Refraction | 22.822 |
| | layer (RQ) | | surface | | | | | | |
| 4 | | S3 | Spherical | Infinite | 3.559 | | | Refraction | 22.822 |
| | | | surface | | | | | | |
| 5 | Second lens (E2) | S4 | Aspheric | 211.7667 | 6 | 1.66 | 20.4 | Refraction | 24.9998 |
| | | | surface | | | | | | |
| 6 | Second lens (E2) | S5 | Fresnel | −78.359 | −6 | | | Reflection | 25.6996 |
| | | | surface | | | | | | |
| 7 | | S4 | Aspheric | 211.7667 | −3.559 | | | Refraction | 24.9998 |
| | | | surface | | | | | | |
| 8 | Quarter-wave plate | S3 | Spherical | Infinite | −0.209 | 1.5 | 57 | Refraction | 22.822 |
| | (QWP) | | surface | | | | | | |
| 9 | Quarter-wave plate | S25 | Spherical | Infinite | 0.209 | | | Reflection | 22.822 |
| | (QWP) | | surface | | | | | | |
| 10 | | S3 | Spherical | Infinite | 3.559 | | | Refraction | 22.822 |
| | | | surface | | | | | | |
| 11 | Second lens (E2) | S4 | Aspheric | 211.7667 | 6 | 1.54 | 56 | Refraction | 24.9998 |
| | | | surface | | | | | | |
| 12 | Partially reflective | S5 | Fresnel | −78.359 | | | | Refraction | 25.6996 |
| | film (BS) | | surface | | | | | | |
| 13 | Image surface | IMG | Spherical | Infinite | 0 | | | Refraction | 14.0003 |
| | | | surface | | | | | | |

In the example, the first side surface S1 of the first lens and the first side surface S4 of the second lens are aspheric surfaces. Table 6 shows a conic coefficient k and higher-order coefficients A₂, A₄, A₆, A₈, A₁₀, A₁₂, A₁₄, A₁₆, and A₁₈ that are applicable to the surfaces S1 and S4-S5 in the example.

TABLE 6

| Surface | | | | | | | | | | |
|---|---|---|---|---|---|---|---|---|---|---|
| number | k | A₂ | A₄ | A₆ | A₈ | A₁₀ | A₁₂ | A₁₄ | A₁₆ | A₁₈ |
| S1 | 5.7300189 | 0 | −7.39E−06 | −7.49E−09 | −2.40E−11 | 5.84E−14 | −1.46E−16 | 0.00E+00 | 0.00E+00 | 0.00E+00 |
| S4 | 12.931347 | 0 | −4.26E−06 | −5.05E−09 | 1.75E−11 | −1.35E−14 | −4.53E−18 | 0.00E+00 | 0.00E+00 | 0.00E+00 |
| S51 | −2.051008 | 6.00E+00 | −5.11E+132 | −1.71E+39 | 0.00E+00 | −9.83E−07 | 2.20E−10 | −5.70E−13 | −4.58E−16 | 1.97E−18 |
| S52 | −2.051008 | 0 | −1.52E−07 | −2.60E−09 | 3.50E−12 | 7.92E−16 | −6.90E−18 | 0.00E+00 | 0.00E+00 | 0.00E+00 |

In the visual optical system according to the example, the total track length TTL is 15.73 mm, the exit pupil distance ED is 15 mm, the half image height ImgH is 14 mm, the maximum half field of view hfov is 50°, the f-number FNO is 3.69, the distance TD from the first side surface of the first lens to the second side surface of the second lens along the optical axis is 13.77 mm, the back focal length BFL is 1.97 mm, the total effective focal length f is 18.43 mm, the effective focal length f1 of the first lens is 110.51 mm, and the effective focal length f2 of the second lens is 105.58 mm.

FIG. 6A shows an astigmatism curve of the visual optical system according to the example and indicates degrees of bending of tangential image surfaces and degrees of bending of sagittal image surfaces corresponding to different fields of view. FIG. 6B shows a distortion curve of the visual optical system according to the example and indicates distortion values corresponding to different fields of view. A distortion value Dist_{0.9} in a field of view of 0.9 is able to be derived from FIG. 6B, where the distortion value Dist_{0.9} is a distortion value in a field of view of 45°. FIG. 6C shows a longitudinal chromatic aberration curve of the visual optical system according to the example and indicates a degree of deviation of a converged focusing point generated after light having different wavelengths passes through the visual optical system. FIG. 6D shows a relative illuminance curve of the visual optical system according to the example and indicates relative illuminance values corresponding to different fields of view of the visual optical system. As can be seen from FIGS. 6A to 6D, the visual optical system according to the example is able to achieve a desirable imaging quality.

### Example 4

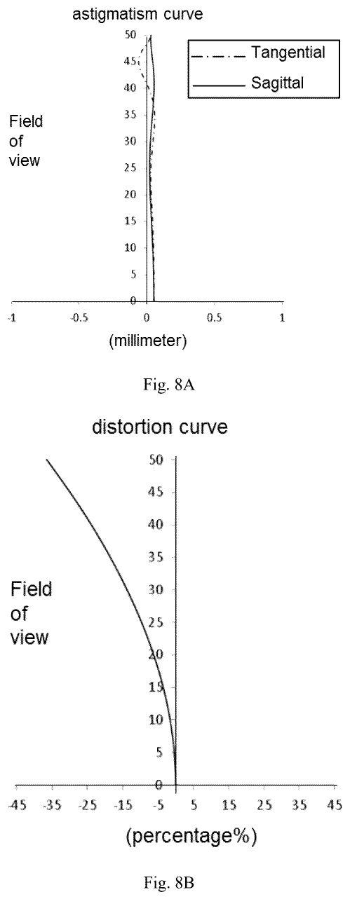

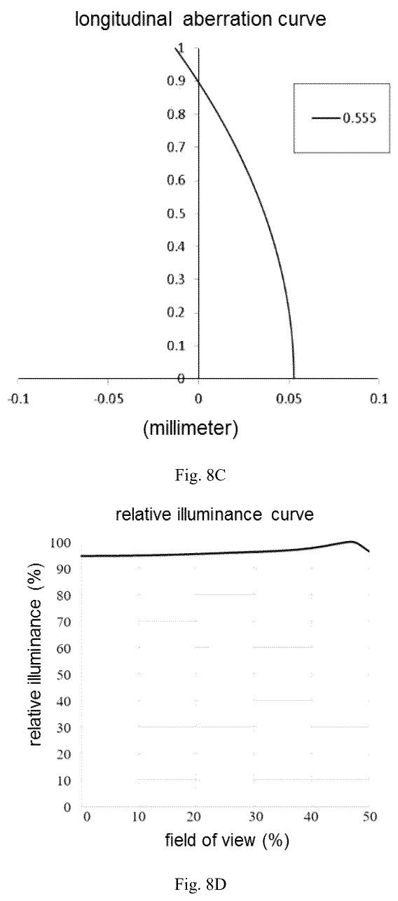

The visual optical system according to the example is described below with reference to FIGS. 7-8D.

As shown in FIG. 7, the visual optical system includes a diaphragm STO, a first lens E1, a composite film layer RQ, a second lens E2, and a partially reflective film BS in sequence from a first side to a second side along an optical axis. The first lens E1 has a positive refractive power, a first side surface S1 of the first lens is a planar surface, and a second side surface S2 of the first lens is a convex surface. The composite film layer RQ is arranged on the second side surface S2 of the first lens, a second side surface S3 of the composite film layer RQ faces away from the first lens E1, the composite film layer RQ includes a polarizing reflective film RP and a quarter-wave plate QWP that are arranged in a stacked manner, and the quarter-wave plate QWP is arranged on a side surface S25, facing away from the first lens, of the polarizing reflective film RP. The second lens E2 has a positive refractive power, a first side surface S4 of the second lens is a concave surface, and a second side surface S5 of the second lens is a convex surface and also a Fresnel surface. The partially reflective film BS is arranged on the second side surface S5 of the second lens. The Fresnel surface consists of a base surface S52 and a Fresnel facet S51. The visual optical system is provided with an image surface IMG located on the second side, the image surface is provided with a display screen, and in a use process, the first side of the visual optical system is closest to human eyes.

After light rays from the image surface IMG is irradiated onto the partially reflective film BS, part of the light rays transmit through the partially reflective film BS and sequentially pass through the second lens E2 and the quarter-wave plate QWP, and then are reflected for the first time at the polarizing reflective film RP. Resulting primarily-reflected light rays sequentially pass through the quarter-wave plate QWP and the second lens E2 and then are reflected for the second time at the partially reflective film BS. Finally, resulting secondarily-reflected light rays sequentially pass through the second lens E2, the quarter-wave plate QWP, the polarizing reflective film RP, the second lens E2, and the diaphragm STO and then enters eyes of a user. Table 7 shows basic parameters of the visual optical system in the example. Units of a radius of curvature and a thickness/distance are millimeter mm. The light from the image surface IMG passes through each element in an order from number 13 to number 1 in Table 7 and is finally projected into the human eyes. “Surface numbers” in rows of number 12 to number 2 correspond to surfaces where refraction or reflection is generated of the “elements” in the corresponding rows. “Thickness/distance” data in the row of number 12 indicate a back focal length of the visual optical system and is equal to the sum of a distance from the partially reflective film BS to the image surface and a center thickness of the partially reflective film BS.

TABLE 7

| | | Surface | Surface | Radius of | Thickness/ | Refractive | Abbe | Refraction/ | Effective |
|---|---|---|---|---|---|---|---|---|---|
| Number | Element | number | type | curvature | distance | index | number | reflection | radius |
| 1 | Diaphragm (STO) | STO | Spherical | Infinite | 15 | | | | 2.5 |
| | | | surface | | | | | | |
| 2 | First lens (E1) | S1 | Spherical | Infinite | 3.5624 | 1.54 | 55.9 | Refraction | 20.3472 |
| | | | surface | | | | | | |
| 3 | Composite film | S2 | Aspheric | −60.7948 | 0.209 | 1.5 | 57 | Refraction | 22.3703 |
| | layer (RQ) | | surface | | | | | | |
| 4 | | S3 | Aspheric | −60.7948 | 2.8877 | | | Refraction | 22.3703 |
| | | | surface | | | | | | |
| 5 | Second lens (E2) | S4 | Aspheric | −80.9232 | 6.0002 | 1.54 | 56 | Refraction | 24.0761 |
| | | | surface | | | | | | |
| 6 | Second lens (E2) | S5 | Fresnel | −41.1663 | −6.0002 | | | Reflection | 24.6982 |
| | | | surface | | | | | | |
| 7 | | S4 | Aspheric | −80.9232 | −2.8877 | | | Refraction | 24.0761 |
| | | | surface | | | | | | |
| 8 | Quarter-wave plate | S3 | Aspheric | −60.7948 | −0.209 | 1.5 | 57 | Refraction | 22.3703 |
| | (QWP) | | surface | | | | | | |
| 9 | Quarter-wave plate | S25 | Aspheric | −60.7948 | 0.209 | | | Reflection | 22.3703 |
| | (QWP) | | surface | | | | | | |
| 10 | | S3 | Aspheric | −60.7948 | 2.8877 | | | Refraction | 22.3703 |
| | | | surface | | | | | | |
| 11 | Second lens (E2) | S4 | Aspheric | −80.9232 | 6.0002 | 1.54 | 56 | Refraction | 24.0761 |
| | | | surface | | | | | | |
| 12 | Partially reflective | S5 | Fresnel | −41.1663 | 1.3487 | | | Refraction | 24.6982 |
| | film (BS) | | surface | | | | | | |
| 13 | Image surface | IMG | Spherical | Infinite | 0 | | | Refraction | 14.0598 |
| | | | surface | | | | | | |

In the example, the second side surface S2 of the first lens and the first side surface S4 of the second lens are aspheric surfaces. Table 8 shows a conic coefficient k and higher-order coefficients A₂, A₄, A₆, A₈, A₁₀, A₁₂, A₁₄, A₁₆, and A₁₈ that are applicable to the surfaces S2-S5 in the example.

TABLE 8

| Surface | | | | | | | | | | |
|---|---|---|---|---|---|---|---|---|---|---|
| number | k | A₂ | A₄ | A₆ | A₈ | A₁₀ | A₁₂ | A₁₄ | A₁₆ | A₁₈ |
| S2 | −2.852663 | 0 | 5.74E−06 | −9.90E−10 | −3.83E−12 | 2.10E−14 | −2.06E−17 | 0.00E+00 | 0.00E+00 | 0.00E+00 |
| S3 | −2.852663 | 0 | 5.74E−06 | −9.90E−10 | −3.83E−12 | 2.10E−14 | −2.06E−17 | 0.00E+00 | 0.00E+00 | 0.00E+00 |
| S4 | −13.37714 | 0 | 3.43E−07 | 2.88E−09 | 3.22E−12 | −9.85E−15 | −1.44E−18 | 0.00E+00 | 0.00E+00 | 0.00E+00 |
| S51 | −0.979553 | 6.00E+00 | −3.97E+132 | −2.61E+35 | 0.00E+00 | −4.24E−07 | 1.40E−10 | 2.00E−12 | −3.30E−15 | 3.21E−19 |
| S52 | −0.979553 | 0 | −3.86E−07 | 6.09E−11 | 1.92E−12 | 4.51E−16 | 3.43E−19 | 0.00E+00 | 0.00E+00 | 0.00E+00 |

In the visual optical system according to the example, the total track length TTL is 14.01 mm, the exit pupil distance ED is 15 mm, the half image height ImgH is 14.06 mm, the maximum half field of view hfov is 50°, the f-number FNO is 3.69, the distance TD from the first side surface of the first lens to the second side surface of the second lens along the optical axis is 12.66 mm, the back focal length BFL is 1.35 mm, the total effective focal length f is 18.44 mm, the effective focal length f1 of the first lens is 113.26 mm, and the effective focal length f2 of the second lens is 145.79 mm.

FIG. 8A shows an astigmatism curve of the visual optical system according to the example and indicates degrees of curvature of tangential image surfaces and degrees of curvature of sagittal image surfaces corresponding to different fields of view. FIG. 8B shows a distortion curve of the visual optical system according to the example and indicates distortion values corresponding to different fields of view. A distortion value Dist_{0.9} in a field of view of 0.9 is able to be derived from FIG. 8B, where the distortion value Dist_{0.9} is a distortion value in a field of view of 45°. FIG. 8C shows a longitudinal chromatic aberration curve of the visual optical system according to the example and indicates a degree of deviation of a converged focusing point generated after light having different wavelengths passes through the visual optical system. FIG. 8D shows a relative illuminance curve of the visual optical system according to the example and indicates relative illuminance values corresponding to different fields of view of the visual optical system. As can be seen from FIGS. 8A to 8D, the visual optical system according to the example is able to achieve a desirable imaging quality.

In conclusion, conditional expressions in Examples 1 to 4 satisfy relations shown in Table 9.

TABLE 9

| | Example | | | |
|---|---|---|---|---|
| Conditional Expression | 1 | 2 | 3 | 4 |
| f1/f2 | 0.89 | 3.12 | 1.05 | 0.78 |
| CT3/CT1 | 0.07 | 0.08 | 0.05 | 0.06 |
| CT1/CT2 | 0.47 | 0.45 | 0.67 | 0.59 |
| BFL/TTL | 0.3 | 0.48 | 0.12 | 0.1 |
| ED/TTL | 0.98 | 0.82 | 0.95 | 1.07 |
| f/TTL × tan(HFOV) | 1.42 | 1.13 | 1.4 | 1.57 |
| \|Dist_{0.9}\| | 28.8% | 26.08% | 29.76% | 29.92% |
| DT21/DT11 | 1.22 | 1.18 | 1.02 | 1.02 |
| CT2 × N2 − CT1 × N1 | 4.93 | 5.85 | 3.08 | 3.75 |
| EPD/ImgH | 0.35 | 0.36 | 0.36 | 0.36 |
| f1/f | 6.22 | 17.3 | 6 | 6.14 |

The above description is merely exemplary of preferred examples of the disclosure and of principles of the technology employed. It should be understood by a person skilled in the art that the scope of invention involved in the disclosure is not limited to the technical solution formed by a specific combination of the above technical features, and should cover other technical solutions formed by any combinations of the above technical features or their equivalent features without departing from the inventive concept, for instance, the technical solution formed by replacing the above features with the technical features having similar functions disclosed in (but not limited to) the disclosure or vice versa.

What is claimed is:

1. A visual optical system, comprising a first lens, a composite film layer, a second lens, and a partially reflective film in sequence from a first side to a second side along an optical axis; wherein each of the first lens and the second lens has a positive refractive power, a first side surface located on the first side, and a second side surface located on the second side;
the composite film layer is arranged on a second side surface of the first lens, the composite film layer comprises a polarizing reflective film and a quarter-wave plate, and the polarizing reflective film is located between the first lens and the quarter-wave plate;
the partially reflective film is arranged on a second side surface of the second lens, and the second side surface of the second lens is a convex surface and also a Fresnel surface; and
an effective focal length f1 of the first lens and an effective focal length f2 of the second lens satisfy: 0.75<f1/f2<3.15.

2. The visual optical system according to claim 1, wherein a center thickness CT1 of the first lens, a center thickness CT2 of the second lens, a refractive index N1 of the first lens, and a refractive index N2 of the second lens satisfy: 3<CT2×N2−CT1×N1<5.9.

3. The visual optical system according to claim 1, wherein an effective radius DT11 of a first side surface of the first lens and an effective radius DT21 of a first side surface of the second lens satisfy: 1<DT21/DT11<1.25.

4. The visual optical system according to claim 1, wherein a back focal length BFL of the visual optical system and a total track length TTL of the visual optical system satisfy: 0.1≤BFL/TTL<0.5.

5. The visual optical system according to claim 1, wherein an exit pupil distance ED of the visual optical system and a total track length TTL of the visual optical system satisfy: 0.8<ED/TTL<1.2.

6. The visual optical system according to claim 1, wherein a total effective focal length f of the visual optical system, a total track length TTL of the visual optical system, and a maximum half field of view hfov of the visual optical system satisfy: 1<f/TTL×tan(hfov)<1.8.

7. The visual optical system according to claim 1, wherein an entrance pupil diameter EPD of the visual optical system and a half image height ImgH of the visual optical system satisfy: 0.35≤EPD/ImgH≤0.36.

8. The visual optical system according to claim 1, wherein a distortion value Dist_{0.9} of the visual optical system in a field of view of 0.9 satisfies: 26%<|Dist_{0.9}|<30%.

9. The visual optical system according to claim 1, wherein one of a first side surface of the first lens, the second side surface of the first lens and a first side surface of the second lens is a planar surface.

10. The visual optical system according to claim 1, wherein the effective focal length f1 of the first lens and a total effective focal length f of the visual optical system satisfy: 6≤f1/f≤17.3.

11. The visual optical system according to claim 1, wherein a center thickness CT1 of the first lens and a center thickness CT2 of the second lens satisfy: 0.3<CT1/CT2<0.8.

12. The visual optical system according to claim 1, wherein a center thickness CT3 of the composite film layer and a center thickness CT1 of the first lens satisfy: 0.05≤CT3/CT1≤0.08.

13. A virtual reality device, comprising the visual optical system according to claim 1.

14. The virtual reality device according to claim 13, wherein a center thickness CT1 of the first lens, a center thickness CT2 of the second lens, a refractive index N1 of the first lens, and a refractive index N2 of the second lens satisfy: 3<CT2×N2−CT1×N1<5.9.

15. The virtual reality device according to claim 13, wherein an effective radius DT11 of a first side surface of the first lens and an effective radius DT21 of a first side surface of the second lens satisfy: 1<DT21/DT11<1.25.

16. The virtual reality device according to claim 13, wherein a back focal length BFL of the visual optical system and a total track length TTL of the visual optical system satisfy: 0.1≤BFL/TTL<0.5.

17. The virtual reality device according to claim 13, wherein an exit pupil distance ED of the visual optical system and a total track length TTL of the visual optical system satisfy: 0.8<ED/TTL<1.2.

18. The virtual reality device according to claim 13, wherein a total effective focal length f of the visual optical system, a total track length TTL of the visual optical system, and a maximum half field of view hfov of the visual optical system satisfy: 1<f/TTL×tan(hfov)<1.8.

19. The virtual reality device according to claim 13, wherein an entrance pupil diameter EPD of the visual optical system and a half image height ImgH of the visual optical system satisfy: 0.35≤EPD/ImgH≤0.36.

20. The virtual reality device according to claim 13, wherein a distortion value Dist_{0.9} of the visual optical system in a field of view of 0.9 satisfies: 26%<|Dist_{0.9}|<30%.
